(19) United States
(12) Patent Application Publication
(10) Pub. No.: US 2007/0116011 A1
(43) Pub. Date: May 24, 2007

(54) Method and apparatus for communications of user equipment using internet protocol address in a mobile communication system

(76) Inventors: Han-Na Lim, Siheung-si (KR); Sung-Ho Choi, Suwon-si (KR); O-Sok Song, Seoul (KR); Eun-Hui Bae, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/544,927

(22) Filed: Oct. 10, 2006

(30) Foreign Application Priority Data
Oct. 7, 2005 (KR) 2005-94611

(51) Int. Cl. H04L 12/56

(52) U.S. Cl. 370/395.52

(57) ABSTRACT

A method and apparatus for communications of a UE using an IP address in a mobile communication system are provided. When the UE moves from an old subnet managed by an old gateway to a new subnet managed by a new gateway, the UE determines whether there are allocated radio resources. In the absence of the allocated radio resources, the UE determines whether an IP-based application service is in progress. If the IP-based application service is in progress, the UE determines to reuse an old IP address in the new subnet. If the IP-based application service is not in progress, the UE determines to use a new IP address in the new subnet. Then the UE sends to the new gateway an RAU request message including an indication indicating whether the old IP address or the new IP address will be used in the new subnet.

### CROSS-REFERENCE TO RELATED APPLICATIONS

This application claims the benefit under 35 U.S.C. § 119(a) of Korean Patent Application No. 2005-94611 filed Oct. 7, 2005, in the Korean Intellectual Property Office, the entire disclosure of which is hereby incorporated by reference.

### BACKGROUND OF THE INVENTION

1. Field of the Invention

The present invention relates generally to a mobile communication system. More particularly, the present invention relates to a method and apparatus for communications using an Internet Protocol (IP) address in a User Equipment (UE).

2. Description of the Related Art

The traditional Internet which provides connectivity to fixed hosts in a wired network has evolved to support UEs roaming from one network to another in a wired-wireless network interworking environment. A protocol developed to support the mobility of such UEs over the Internet is IP. Mobile IP enables a UE to continue on-going communications with a Correspondent Node (CN) even after the UE changes its point of access to an Internet link. In Mobile IP, however, the UE has to support a mobile IP stack and a network has to support new entities such as a Home Agent (HA) and a Foreign Agent (FA).

A mobile communication network is typically configured to include a Node B wirelessly connectable to the UE and a GateWay (G/W) for connecting the Node B to an IP network. The G/W functions to connect the UE connected to the Node B over a wireless network to the IP network inside or outside the wireless network. The coverage area of the G/W is called a subnet. The G/W allocates an IP address to a UE within the subnet, and manages and maintains the mobility of the UE. The Node B provides radio resources to the UE so that the UE can connect to the IP network via the G/W. The IP network is defined as a network for providing an IP service to the UE, like the Internet.

FIG. 1 is a diagram illustrating a signal flow for a conventional operation in the G/W for managing communications of UEs. In the following procedure, a UE 100 notifies a G/W 102 to which it belongs of a change of its routing area. The UE 100 is aware of entry into a new routing area by a Routing Area Identification (RAI) included in information broadcast from a Node B.

Referring to FIG. 1, when the UE 100 moves to a new routing area, it sends a Routing Area Update (RAU) request message to the G/W 102 in step 104. The RAU request message contains an old RAI, a new RAI, and an old Primary Temporary Mobile Station/Subscriber Identity (P-TMSI).

The old RAI is the ID of an old routing area before the movement of the UE 100, and the new RAI is the ID of the new routing area acquired from the broadcast information. A P-TMSI is a unique ID identifying the UE 100 within a routing area and thus the old P-TMSI identifies the UE 100 within the old routing area.

After the G/W 102 receives the RAU request message, security functions are performed between the UE 100 and the G/W 102, when needed in step 106. Then the G/W 102 allocates a new P-TMSI to the UE 100 and notifies the UE 100 of the new P-TMSI by an RAU accept message in step 108. The UE 100 replies with an RAU complete message in step 110, thus completing the routing area update.

The development of communication technology and a variety of demands from users and service provides have driven the use of a plurality of G/Ws in communication networks. The G/Ws manage the IP addresses of UEs within their subnets and a UE moving between subnets is allocated a new IP address.

According to the above-described conventional technology, when the UE moves to the service area of a new G/W, it cannot reuse an old IP address used in the subnet of an old G/W. In a system with a plurality of G/Ws, the change of the G/W managing the UE leads to the change of the IP address, thus causing service interruptions. Therefore, it is impossible to provide a seamless service to the UE.

Accordingly, there is a need for an improved method and apparatus for controlling communications of a user equipment using internet protocol.

### SUMMARY OF THE INVENTION

Exemplary embodiments of the present invention address at least the above problems and/or disadvantages and provide at least the advantages described below. Accordingly, an aspect of the present invention is to provide a method and apparatus for allocating a new IP address to a UE or allowing the UE to reuse an old IP address according to the radio resource and service status of the UE.

According to one exemplary aspect of the present invention, in a method of communicating using an IP address in a UE in a mobile communication system, when the UE moves from an old subnet managed by an old gateway to a new subnet managed by a new gateway, it determines whether there are its allocated radio resources. In the absence of the allocated radio resources, the UE determines whether an IP-based application service is in progress. If the IP-based application service is in progress, the UE determines to reuse an old IP address in the new subnet. The old IP address is an IP address used in the old subnet. If the IP-based application service is not in progress, the UE determines to use a new IP address in the new subnet. Then the UE sends to the new gateway an RAU request message including an indication indicating whether the old IP address or the new IP address will be used in the new subnet.

According to another exemplary aspect of the present invention, in a method of supporting communications of a UE using an IP address in a new gateway in a mobile communication system, the new gateway receives an RAU request message from the UE, when the UE in an idle state moves from an old subnet managed by an old gateway to a new subnet managed by the new gateway. The new gateway determines whether the UE will reuse an old IP address in the new subnet, referring to an indication included in the RAU request message. The old IP address is an IP address used in the old subnet. If the indication indicates that the old IP address will be reused, the new gateway registers the old IP address in a routing table for the UE so that the old IP address can be used in the new subnet. If the indication indicates that the old IP address will not be reused, the new gateway acquires a new IP address and stores the new IP address for the UE. Here, the indication is decided according to whether the UE has allocated radio resources and an IP-based application service is in progress for the UE, when the UE moves to the new subnet.

According to a third exemplary aspect of the present invention, in a method of supporting communications of a UE using an IP address in an old gateway in a mobile communication system, the old gateway receives a gateway context request message from a new gateway, when the UE in an idle state moves from an old subnet managed by the old gateway to a new subnet managed by the new gateway. The old gateway determines whether the UE will reuse an old IP address in the new subnet, the old IP address being an IP address used in the old subnet, referring to an indication included in the gateway context request message. The old gateway registers a new RAI being an ID of a new RA to which the UE moves, and a new P-TMSI allocated to the UE by the new gateway in a routing table for the UE. Here, the indication is decided according to whether the UE has allocated radio resources and an IP-based application service is in progress for the UE, when the UE moves to the new subnet.

According to a fourth exemplary aspect of the present invention, in an apparatus for communicating using an IP address in a UE in a mobile communication system, a controller determines whether an IP-based application service is in progress for the UE, when the UE in an idle state moves from an old subnet managed by an old gateway to a new subnet managed by a new gateway, determines to reuse an old IP address in the new subnet, the old IP address being an IP address used in the old subnet, if the IP-based application service is in progress, determines to use a new IP address in the new subnet, if the IP-based application service is not in progress, and generates an indication indicating whether the old IP address or the new IP address will be used in the new subnet. A transmitter sends an RAU request message including the indication to the new gateway.

According to a fifth exemplary aspect of the present invention, in a mobile communication system, a plurality of gateways are connected to an IP network. A UE capable of communicating using radio resources and supporting an IP-based application service determines whether an IP-based application service is in progress for the UE, when the UE in an idle state moves from an old subnet managed by an old gateway to a new subnet managed by a new gateway. If the IP-based application service is in progress, the UE determines to reuse an old IP address in the new subnet. The old IP address is an IP address used in the old subnet. If the IP-based application service is not in progress, the UE determines to use a new IP address in the new subnet. Then the UE sends to the new gateway an RAU request message including an indication indicating whether the old IP address or the new IP address will be used in the new subnet.

According to a sixth exemplary aspect of the present invention, in a method of communicating using an IP address in a UE in a mobile communication system, the UE moves from an old subnet managed by an old gateway to a new subnet managed by a new gateway. It sends a request message including an old IP address used in the old subnet to the new gateway in order to request reuse of the old IP address in the new subnet. The UE receives from the new gateway a response message indicating the old IP address can be used in the new subnet.

According to a seventh exemplary aspect of the present invention, in a method of supporting communications of a UE using an IP address in a new gateway in a mobile communication system, the new gateway receives from the UE a request message with an old IP address used in an old subnet, requesting reuse of the old IP address in a new subnet, when the UE moves from the old subnet managed by an old gateway to the new subnet managed by the new gateway. The new gateway registers the old IP address in a routing table for the UE so that the old IP address can be used in the new subnet, and sends to the UE a response message indicating that the old IP address can be used in the new subnet.

According to an eighth exemplary aspect of the present invention, in a mobile communication system, a plurality of gateways are connected to an IP network. When a UE capable of communicating using radio resources and supporting an IP-based application service moves from an old subnet managed by an old gateway to a new subnet managed by a new gateway, it sends a request message including an old IP address used in the old subnet to the new gateway in order to request reuse of the old IP address in the new subnet, and receives from the new gateway a response message indicating the old IP address can be used in the new subnet.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a signal flow for a conventional operation in the G/W for managing communications of UEs;

FIG. 2 illustrates the configuration of a mobile communication network to which an exemplary embodiment of the present invention is applied;

FIG. 3 is a flowchart illustrating a UE's operation when the UE moves from an old subnet to a new subnet according to an exemplary embodiment of the present invention;

FIG. 4 is a flowchart illustrating a new G/W's operation when the UE moves from the old subnet to the new subnet according to an exemplary embodiment of the present invention;

FIG. 5 is a flowchart illustrating an old G/W's operation when the UE moves from the old subnet to the new subnet according to an exemplary embodiment of the present invention;

FIG. 6 is a diagram illustrating a signal flow for changing the IP address of the UE when the UE moves from the old subnet to the new subnet in an IP_RESET mode according to an exemplary embodiment of the present invention;

FIG. 7 is a diagram illustrating a signal flow for reusing the IP address of the UE when the UE moves from the old subnet to the new subnet in an IP_PRESERVE mode according to an exemplary embodiment of the present invention;

FIG. 8 illustrates packet transmission to the UE via the old G/W when the UE moves from the old subnet to the new subnet according to an exemplary embodiment of the present invention;

FIG. 9 illustrates packet transmission to the UE via the old G/W and the new G/W when the UE moves from the old subnet to the new subnet according to an exemplary embodiment of the present invention; and

FIG. 10 is a block diagram of the UE according to an exemplary embodiment of the present invention.

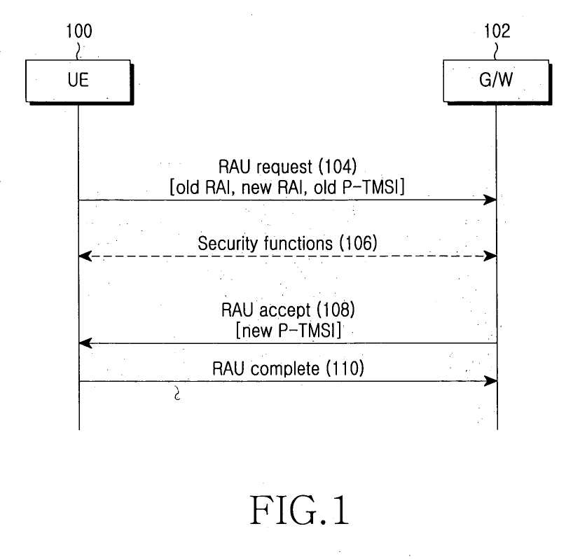

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness. Exemplary embodiments of the present invention will be described herein below with reference to the accompanying drawings.

Exemplary embodiments of the present invention are intended to provide a technique for allocating a new IP address to a UE or allowing the UE to reuse an old IP address by identifying the state of the UE defined according to radio resource allocation and service provisioning to the UE, when a UE enters into a new subnet. If the UE reuses the old IP address in the new subnet, it sends the old IP address directly to a new G/W managing the new subnet so that the new G/W can manage the old IP address.

While exemplary embodiments of the present invention will be described in detail in the context of nodes and messages used in a particular system, it is clearly understood to those skilled in the art that a UE's IP address management according to exemplary embodiments of the present invention can be carried out in any other mobile communication system with a similar technological background and channel structure with a slight modification which is within the scope of the present invention.

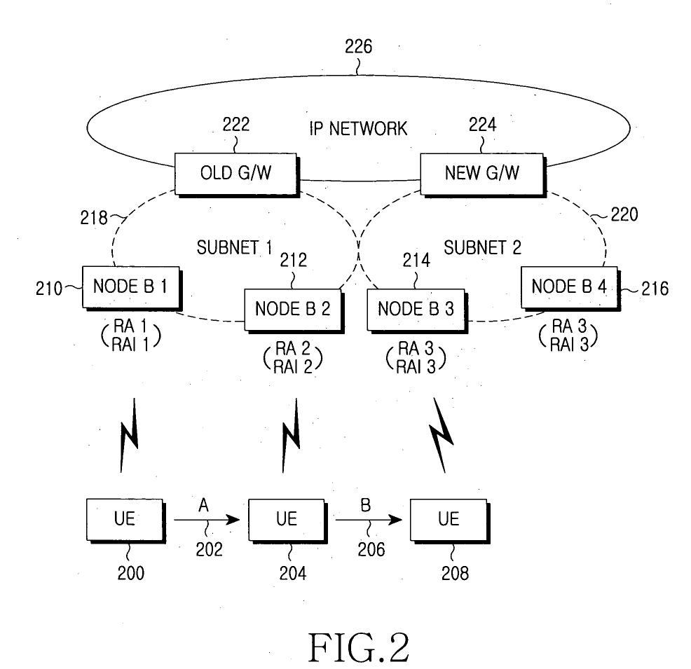

FIG. 2 illustrates the configuration of a mobile communication network to which exemplary embodiments of the present invention are applied. In the illustrated case of FIG. 2, a UE moves between subnets.

Referring to FIG. 2, an old G/W (O-G/W) 222 manages a first subnet 218 (subnet 1), and first and second Node Bs 210 and 212 (Node B 1 and Node B 2) reside within subnet 1. The O-G/W, as does a new G/W, provides a connection between the Node Bs and the IP Network 226. Node B 1 is located in a first Routing Area (RA) (RA 1), and Node B 2 is located in a second RA (RA 2). An RA is a logical area within which an incoming message from a source entity is routed to a UE and an outgoing message from the UE is routed to a destination entity. The ID of RA 1 is a first RAI (RAI 1), and the ID of RA 2 is a second RAI (RAI 2).

Initially, a UE 200 communicates with Node B 1 in subnet 1 under management of the O-G/W 222. During the communications, the UE 200 is connected to Node B 2 belonging to a new G/W (N-G/W) 224 by inter-RA movement 202 (movement A). The UE 200 (in other words 204) accesses a third Node B 214 (Node B 3) by inter-subnet movement 206 (movement B). The N-G/W 224 manages a second subnet 220 (subnet 2) and a third Node B 214 (Node B 3) and a fourth Node B 216 (Node B 4) are located in subnet 2. Node B 3 and Node B 4 are within a third RA (RA 3) and thus have the same RAI, RAI 3.

As described above, the RA change may cause the change of the subnet or not. The movement 202 is made from RA 1 to RA 2. Despite the movement 202, the UE 204 maintains its IP address unchanged because it is still in the same subnet 218. On the other hand, the movement 206 is made from RA 2 to RA 3, and the UE 204 (in other words 208) is in subnet 2 after the movement 206. With the inter-subnet movement 206, the UE 208 is allocated a new IP address by the N-G/W 224.

As a result, an on-going service for the UE 208 is interrupted. Accordingly, there exists a need for deciding as to whether an IP-based application service is in progress for the UE 208.

A plurality of LE modes are defined depending on whether radio resources are in use or not for the UE. When the LE is allocated radio resources and a call is in progress, it is in a CONNECTED state. If the radio resources are not used, the LE is in an IDLE state. For example, the LE conducts a voice call with the other party or receives data streams continuously from a streaming server in the CONNECTED state. According to the 3rd Generation Partnership Project (3GPP) Long Term Evolution (LTE) standard, an LTE Active state and an LTE IDLE state are equivalent to the CONNECTED state and the IDLE state, respectively.

It may occur that the UE is receiving a particular service without occupying radio resources. For example, a File Transfer Protocol (FTP) service or a HyperText Transfer Protocol (HTTP) service is bursty rather than continuous. In this case, the UE is neither fully in the CONNECTED state nor in the IDLE state. The state where a call is connected (in other words a service application is in progress) but no file transmission using radio resources takes place is defined as an IP_PRESERVE mode, and the rest IDLE state is defined as an IP_RESET mode.

In other words, the UE in the IDLE state can be in the IP_PRESERVE mode or the IP_RESET mode depending on whether the LE is receiving an application service. The IP_PRESERVE mode is an IDLE+ state in which no data transmission is carried out using radio resources with an application service in progress. When the UE is in this IP_PRESERVE mode, not the Node B but the G/W manages a context required for the communications of the LE (hereinafter, referred to as a LE context). The IP_RESET mode is an IDLE-state where the UE is not receiving the application service, in other words the call is not connected. If the UE is in the IP_RESET mode, the UE context is maintained in neither the Node B nor the G/W. In case of inter-subnet movement, the UE is allocated a new IP address or reuses an old IP address according to its state.

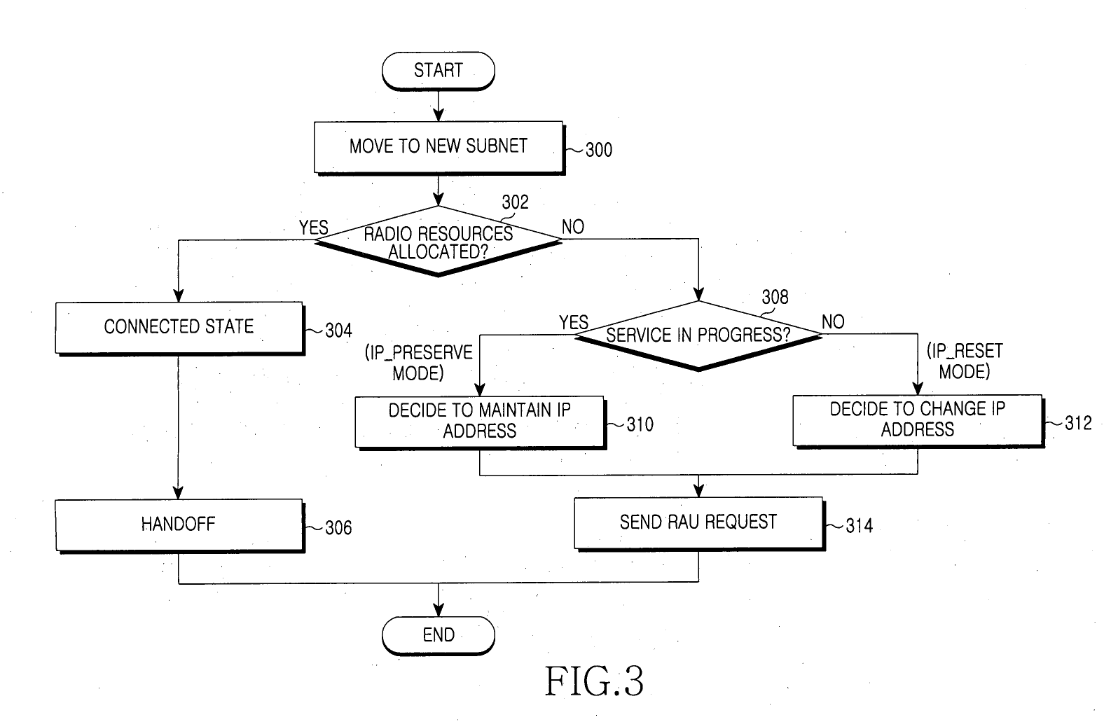

FIG. 3 is a flowchart illustrating an operation of the UE according to an exemplary embodiment of the present invention.

Referring to FIG. 3, the UE detects its movement into a new subnet by system information broadcast from the Node B in step 300 and determines whether available radio resources have been allocated to the UE in step 302. In the presence of allocated radio resources, the UE considers that it is in the CONNECTED state in step 304 and continues communications in a general procedure in step 306.

In the absence of the allocated radio resources, the UE determines whether an IP-based application service is in progress, considering that it is in the IDLE state in step 308. If the service is in progress, the UE determines to reuse an old IP address used in an old subnet in the new subnet considering that it is in the IP_PRESERVE mode in step 310. On the contrary, if the service is not on-going, the UE determines to be allocated a new IP address in the new subnet, considering that it is in the IP_RESET mode in step 312.

In step 314, the UE sends an indication indicating reuse of the old IP address or allocation of the new IP address to the N-G/W of the new subnet. Then the UE communicates using the old IP address or the new IP address in the new subnet. The indication may be included in an RAU request message that the UE sends to the N-GW in the IDLE state in order to notify the entry into the new subnet.

That is, the UE adds the indication indicating whether its IP address will be maintained or changed to the RAU request message delivered to notify the N-G/W of the entry into the new subnet. The new G/W determines from the indication set in the received RAU request message whether to operate in the IP_PRESERVE mode or the IP_RESET mode.

The indication includes at least one of a 1-bit con-indicator, indicating whether the IP address is maintained or changed, and the old IP address. If the con-indicator is “1”, this implies that the UE's IP address will be changed. If the con-indicator is “0”, this implies that the UE's IP address will be kept unchanged. While it is described herein that the con-indicator is 1 bit, it can be one or more bits depending on system implementation. The con-indicator is determined at the application level of the UE, that is, at a layer above an IP level. When the UE is receiving an application/service (for example TCP/IP service) requiring no IP change for its seamless provisioning, it sets the con-indicator to “0”. In another case, the UE sends the old IP address in the RAU request message. The N-G/W uses the old IP address for the UE in the new subnet when the received RAU request message includes the old IP address of the UE.

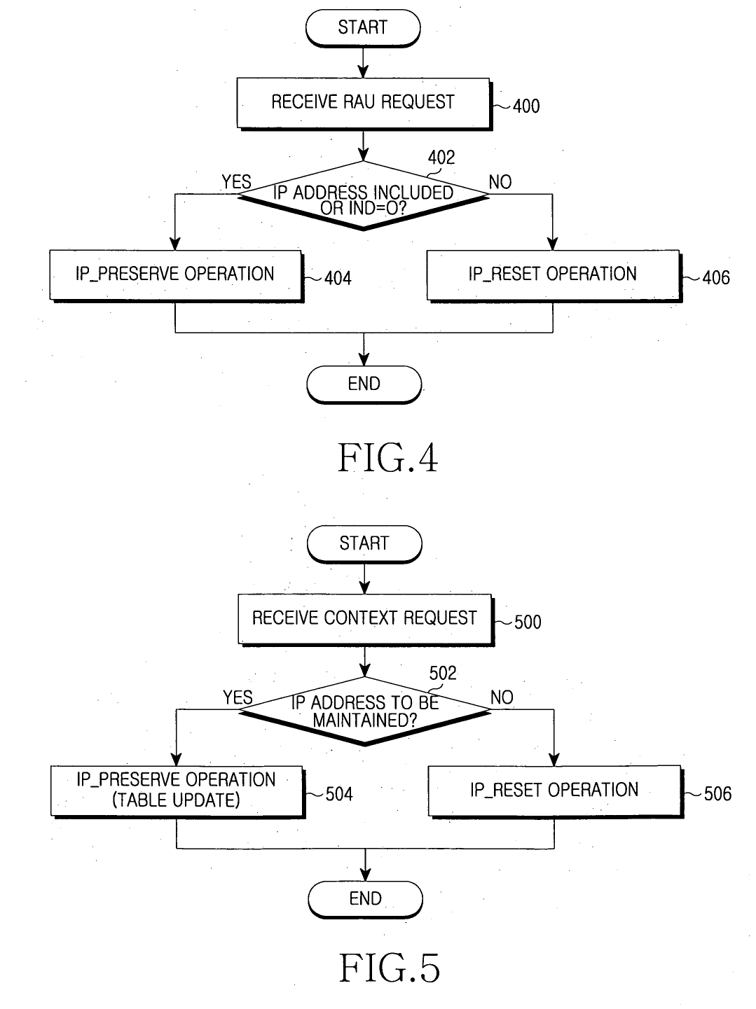

FIG. 4 is a flowchart illustrating an operation of the N-G/W according to an exemplary embodiment of the present invention.

Referring to FIG. 4, upon receipt of the RAU request message from the UE in step 400, the N-G/W checks whether an indication included in the RAU request message indicates maintenance of the IP address of the UE in step 402 and operates in the IP_PRESERVE mode (step 404) or in the IP_RESET mode (step 406) according to the value of the indication.

The IP_PRESERVE mode operation is that the N-G/W registers the old IP address of the UE in a routing table in order to reuse the old IP address for communications of the UE in the new subnet. The N-G/W may acquire the old IP address from the UE or query the O-G/W for the old IP address.

The IP_RESET mode operation is that the N-G/W uses a new IP address for the UE's communications in the new subnet. The new IP address is allocated to the UE by the N-G/W or generated from the UE itself.

If a con-indicator is used as the indication and it is set to 0, the N-G/W operates in the IP_PRESERVE mode in step 404. If the con-indicator is 1, the N-G/W operates in the IP_RESET mode in step 406.

If the old IP address is used as the indication and included in the RAU request message, the N-G/W operates in the IP_PRESERVE mode in step 404. In the absence of the old IP address, the N-G/W operates in the IP_RESET mode in step 406.

After receiving the RAU request message from the UE, the N-G/W notifies the O-G/W whether it will operate in the IP_PRESERVE mode or in the IP_RESET mode. The O-G/W decides as to whether to operate in the IP_PRESERVE mode or in the IP_RESET mode according to the information received from the N-G/W.

FIG. 5 is a flowchart illustrating an operation of the O-G/W according to an exemplary embodiment of the present invention.

Referring to FIG. 5, the O-G/W receives from the N-G/W a Gateway Context Request message indicating that the UE has moves from an old subnet of the O-G/W to the new subnet of the N-G/W in step 500 and checks an indication indicating whether the IP address of the UE is to be changed in the Gateway Context Request message in step 502. The indication can be an afore-mentioned con-indicator, for example. In this case, the O-G/W determines whether the con-indicator is 0. If the con-indicator is 0, which implies that the IP address will be maintained, the O-G/W operates in the IP_PRESERVE mode in step 504. On the contrary, if the con-indicator is 1, which implies that the IP address will be changed, the O-G/W operates in the IP_RESET mode in step 506.

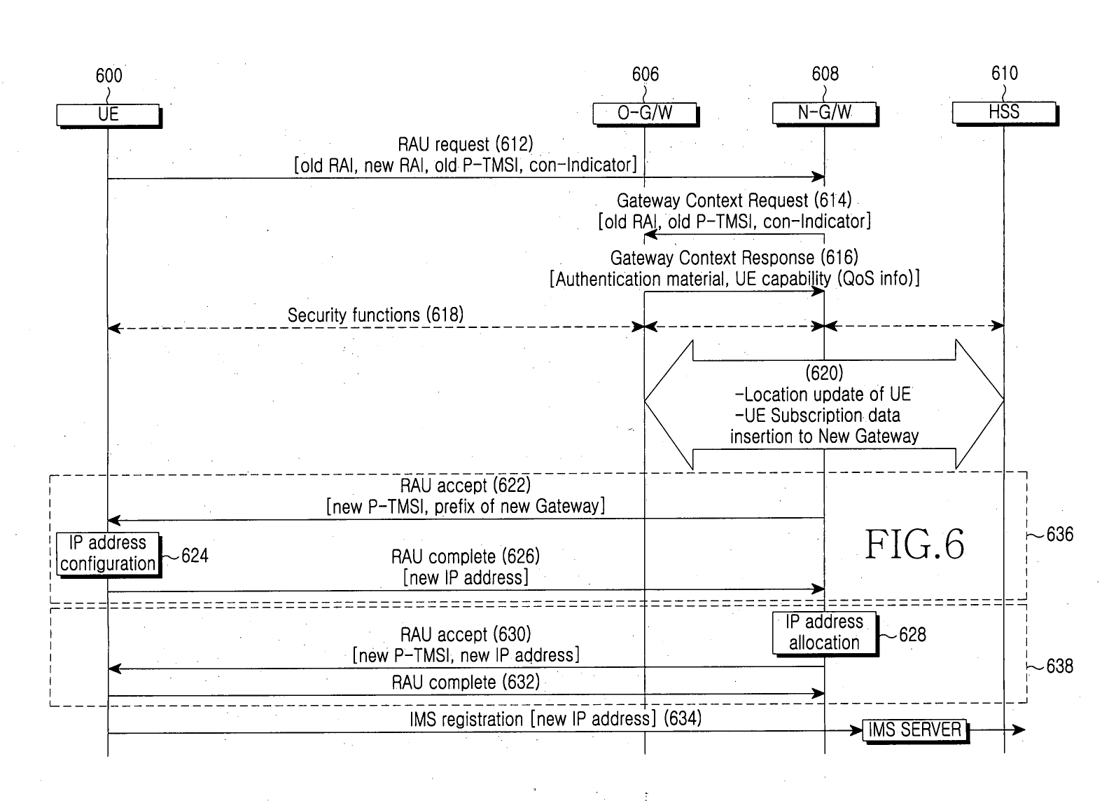

FIG. 6 is a diagram illustrating a signal flow for changing the IP address of the UE when the UE moves from the old subnet to the new subnet in the IP_RESET mode according to a preferred embodiment of the present invention.

Referring to FIG. 6, a UE 600 detects its movement into a new RA and sends an RAU request message to an N-G/W 608 in step 612. The RAU request message contains an old RAI, a new RAI, and old P-TMSI, and a con-indicator. In the illustrated case of FIG. 2, the old RAI is RAI 2 and the new RAI is RAI 3. The UE 600 moves from subnet 1 to subnet 2 and the con-indicator is set to 1 to indicate that the IP address of the UE 600 is to be changed. It can be further contemplated as another exemplary embodiment that if the change of the IP address is requested by excluding the old IP address from the RAU request message, the con-indicator is omitted.

Upon receipt of the RAU request message, the N-G/W 608 sends to an O-G/W 606 a Gateway Context Request message to acquire a UE context from the O-G/W 606 in step 614. The Gateway Context Request message contains the old RAI, the old P-TMSI, and the con-indicator. The old P-TMSI is used to detect the context of the UE 600 among UE contexts stored in the O-G/W, and the con-indicator is set to 1 as received from the UE 600. It can be further contemplated as another exemplary embodiment that if the change of the IP address is requested by excluding the old IP address from the RAU request message, the N-G/W 608 generates a con-indicator to be included in the Gateway Context Request message.

In step 616, the O-G/W 606 sends the UE context for the UE 600 to the N-G/W 608 by a Gateway Context Response message. The N-G/W 608 stores the UE context included in the received Gateway Context Response message. Thereafter, unless otherwise specified by the network, the O-G/W 606 does not need to maintain UE information including the old IP address of the UE 600. The UE context contains authorization information and Quality of Service (QoS) information. It may further include other information. In step 618, a security-related operation can be performed between the UE 600 and the N-G/W 608 and between the N-G/W 608 and a Home Subscriber Server (HSS) 610. The HSS 610 stores and manages subscription information and location information of the UE 600. The O-G/W 606, the N-G/W 608 and the HSS 610 update the location information of the UE 600 and the N-G/W 608 stores subscriber data of the UE 600 received from the HSS 610 in step 620. In this way, when the HSS 610 recognizes the movement of the UE 600 to the N-G/W 608, it can command deletion of the UE information of the UE 600 to the O-G/N 606.

The following operation after step 620 can be embodied in at least two ways. One exemplary method, shown in step 636, is that the UE 600 itself generates an IP address. Specifically, the N-G/W 608 allocates a new P-TMSI to the UE 600 in step 622. The new P-TMSI together with the address prefix of the N-G/W 608 is sent to the UE 600 by an RAU accept message. The UE 600 generates a new IP address for use in the new subnet, referring to the address prefix of the new N-G/W 608 in step 624 and notifies the N-G/W 608 of the new IP address by an RAU complete message in step 626.

Another exemplary operation, shown in step 638, is that the N-G/W 608 generates a new IP address and allocates it to the UE 600. Specifically, the N-G/W 608 generates and stores the new IP address for the UE 600 to use in the new subnet in step 628 and sends the new IP address together with a new P-TMSI to the UE 600 by an RAU accept message in step 630. In step 632, the UE 600 replies with an RAU complete message.

After the IP address allocation by the operation 636 or 638, the N-G/W 608 stores the new IP address in a routing table for the UE 600 so that the UE 600 can use the new IP address for communications in the subnet of the N-G/W 608.

After acquiring the new IP address, the UE 600 sends an IP Multimedia Subsystem (IMS) registration message including the new IP address to a server for managing packet communications over an IP network, for example, an IMS server in step 634. Thus, the UE 600 is able to send packet data by paging.

The IMS server, which is defined in the 3GPP, functions to provide an IP service to subscribers. The IMS registration message is used to register the UE 600 to the IMS server.

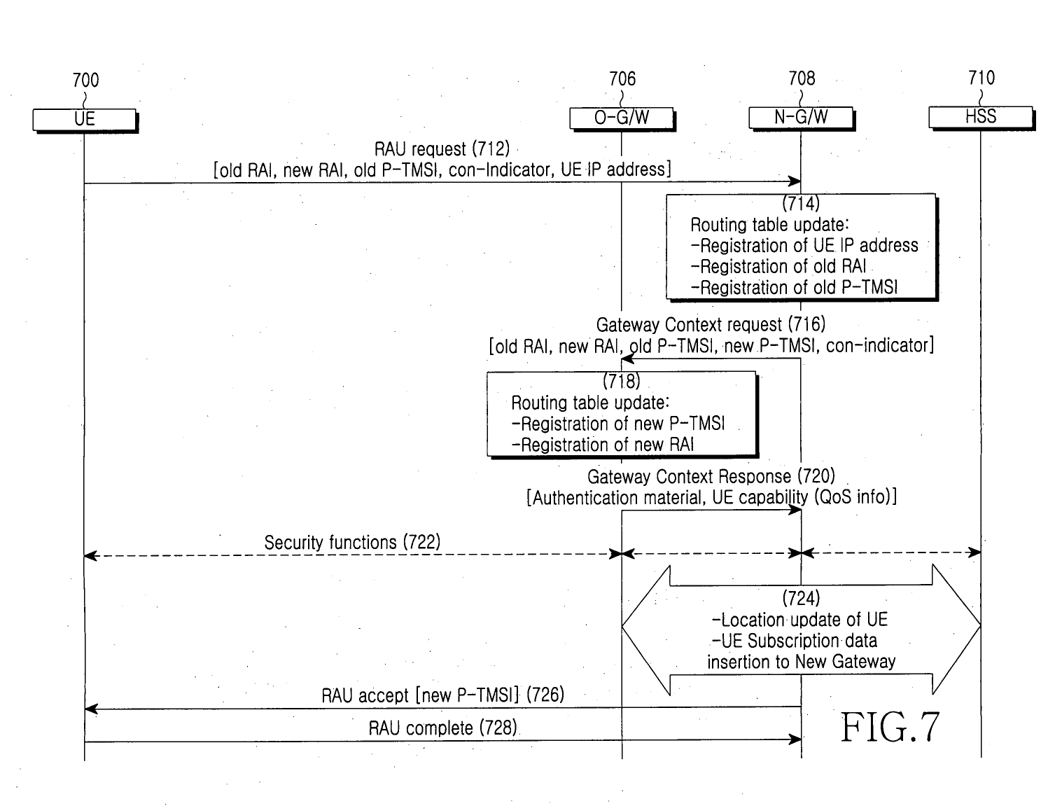

FIG. 7 is a diagram illustrating a signal flow for reusing the IP address of the UE when the UE moves from the old subnet to the new subnet in the IP_PRESERVE mode according to an exemplary embodiment of the present invention.

Referring to FIG. 7, a UE 700 detects its movement into a new RA and sends an RAU request message to an N-G/W 708 in step 712. The RAU request message contains an old RAI, a new RAI, an old P-TMSI, a con-indicator, and the old IP address of the UE 700. The old RAI, the new RAI, and the old P-TMSI have been described earlier. The con-indicator is set to 0 to indicate that the IP address of the UE 700 will not be changed. The old IP address is the IP address of the UE 700 used in an old subnet and will be reused in the new subnet. It can be further contemplated as another exemplary embodiment that if the maintenance of the IP address is requested by including the old IP address in the RAU request message, the con-indicator can be omitted. In a further exemplary embodiment of the present invention, the RAU request message includes both the con-indicator and the old IP address.

Upon receipt of the RAU request message, the N-G/W 708 updates a routing table for the UE 700 by registering the old IP address, the old RAI, and the old P-TMSI in the routing table in step 714. Thus, the old IP address can be used in the new subnet of the N-G/W 708. After the routing table update, the N-G/W 708 sends to an O-G/W 706 a Gateway Context Request message to acquire a UE context from the O-G/W 706 in step 716. The Gateway Context Request message contains the old RAI, the new RAI, the old P-TMSI, a new P-TMSI, and the con-indicator. It can be further contemplated as another exemplary embodiment that if the reuse of the IP address is requested by including the old IP address in the RAU request message, the old IP address is included in the Gateway Context Request message, instead of the con-indicator.

In step 718, the O-G/W 706 updates its routing table for the UE 700 by registering information about the N-G/W 706, the new P-TMSI, and the new RAI based on the Gateway Context Request message. Then the O-G/W 706 replies with a Gateway Context Response message including the UE context in step 720. Since the routing table already has the old IP address of the UE 700, the old IP address of the UE 700 is managed by both the O-G/W 706 and the N-G/W 708 in effect. In step 722, a security-related operation can be performed between the UE 700 and the N-G/W 708 and between the N-G/W 708 and an HSS 710. The O-G/W 706, the N-G/W 708 and the HSS 710 update the location information of the UE 700 and the N-G/W 708 stores subscriber data of the UE 700 received from the HSS 710 in step 724.

After the registration of the old IP address of the UE 700 for use in the new subnet, the N-G/W 708 sends an RAU accept message including the new P-TMSI to the UE 700 in step 726. In step 728, the UE 700 replies with an RAU complete message. Thus, the UE 700 is able to send packet data by paging.

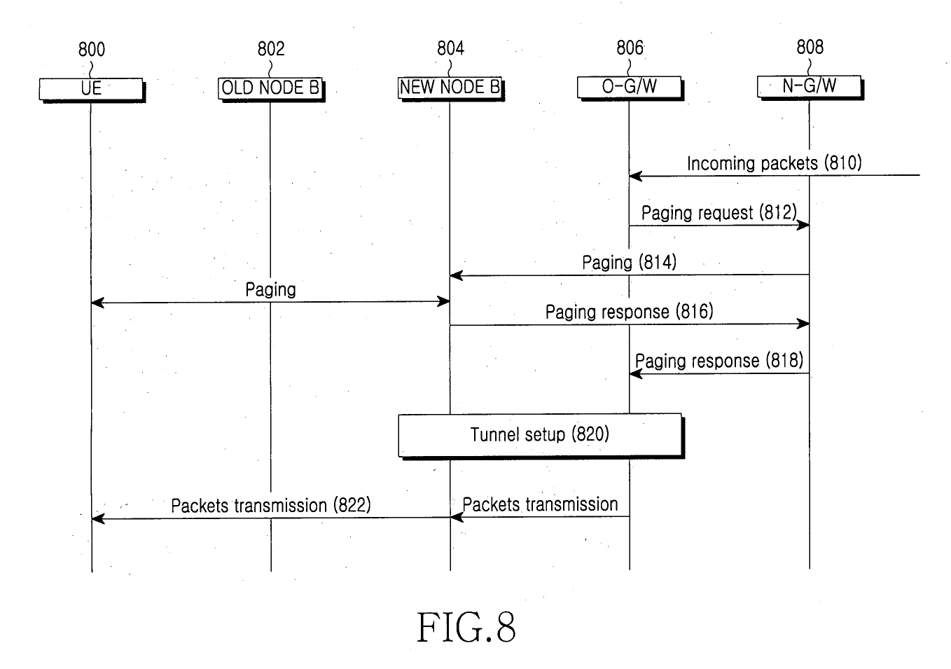

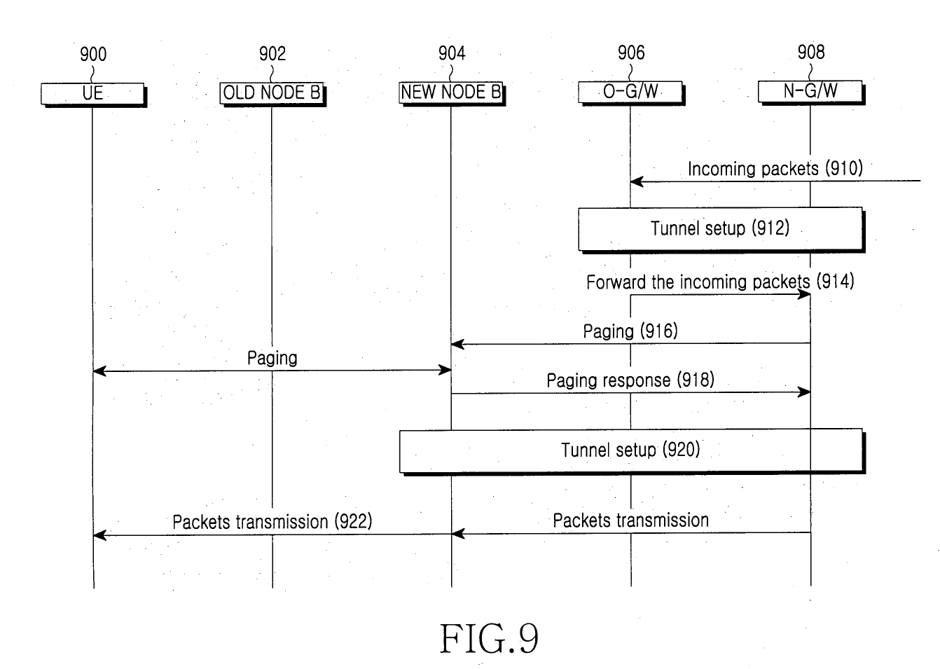

When the UE moves to the new subnet in the above procedures, incoming packets for the UE in the IP_PRESERVE mode are delivered to the O-G/W because their destination address is set to the subnet address of the O-G/W: Hereinbelow, an exemplary method of sending the packets to the UE which has moved to the new subnet through paging will be described. The path of the incoming packets to the UE after the inter-subnet movement depends on whether a data tunnel is established between the O-G/W and a new Node B (FIG. 8) or between the O-G/W and the N-G/W (FIG. 9).

FIG. 8 illustrates packet transmission to the UE via the O-G/W according to an exemplary embodiment of the present invention. A UE 800 moves from an old subnet to a new subnet during communicating with an O-G/W 806 via an old Node B 802, and after the inter-subnet movement, communicates with an N-G/W 808 through a new Node B 804.

Referring to FIG. 8, incoming packets for the UE 800 are delivered to the O-G/W 806 in step 810. The O-G/W 806 sends a paging request message to the N-G/W 808 to which the UE 800 now belongs, referring to the location information of the UE 800 in step 812.

In step 814, the N-G/W 808 broadcasts the paging request message to Node Bs within its subnet and the Node Bs page the UE 800 according to the paging request message. The new Node B 804 covering the UE 800 receives a paging response message from the UE 800.

The new Node B 804 sends the paging response message to the N-G/W 808 in step 816 and the N-G/W 808 sends the paging response message with information about the new Node B 804 to the O-G/W 806 in step 818. The O-G/W 806 establishes a data tunnel with the new Node B 804 based on the information about the new Node B 804 in step 820 and forwards the packets to the UE 800 via the data tunnel in step 822. In this way, packets from the IP network are delivered to the UE 800 using the old IP address.

FIG. 9 illustrates packet transmission to the UE via the old G/W and the new G/W according to an exemplary embodiment of the present invention. A UE 900 moves from an old subnet to a new subnet during communicating with an O-G/W 906 via an old Node B 902, and after the inter-subnet movement, communicates with an N-G/W 908 through a new Node B 904.

Referring to FIG. 9, incoming packets for the UE 900 are delivered to the O-G/W 906 in step 910. The O-G/W 906 establishes a data tunnel with the N-G/W 908 in step 912 and forwards the packets to the N-G/W 908 via the data tunnel in step 914.

The N-G/W 908 broadcasts a paging request message for the received packets to Node Bs within its subnet and the Node Bs page the UE 900 according to the paging request message in step 916. The new Node B 904 covering the UE 900 receives a paging response message from the UE 900.

The new Node B 904 sends the paging response message to the N-G/W 908 in step 918. In step 920, the N-G/W 908 establishes a data tunnel with the new Node B 904. Then, the N-G/W 908 forwards the packets to the LE 900 via the data tunnel between the N-G/W 908 and the new Node B 904 in step 922.

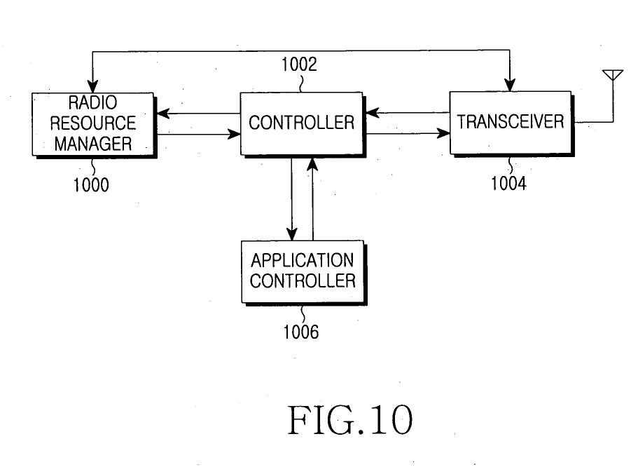

FIG. 10 is a block diagram of the UE according to an exemplary embodiment of the present invention. Only components related to the operation of the present invention are shown.

Referring to FIG. 10, the UE includes a radio resource manager 1000, a controller 1002, a transceiver 1004, and an application controller 1006. The controller 1002 determines whether the LE has moved from the subnet of the O-G/W to the subnet of the N-G/W based on information broadcast by the Node B. If the UE has moved to the new subnet, the controller 1002 determines whether the UE is in the CONNECTED state or in the IDLE state by querying the radio resource manager 1000 whether radio resources were allocated to the UE.

In the presence of allocated radio resources for the UE, the controller 1002 queries the application controller whether the UE is using an IP-based application service. If the IP-based application service is in progress, the controller 1002 determines that the LE is in the IP_PRESERVE mode and otherwise, the controller 1002 determines that the LE is in the IP_RESET mode. The controller 1002 generates an RAU request message according to the mode of the LE, including at least one of a con-indicator and the old IP address of the UE as an indication indicating whether the old IP address will be reused or changed in the new subnet. The RAU request message is sent to the N-G/W through the transceiver 1004. Then the controller 1002 completes an RAU by exchanging messages illustrated in FIGS. 6 and 7 through the transceiver 1004. Thus, the UE is able to exchange packets through the N-G/W.

In accordance with exemplary embodiments of the present invention as described above, since it is determined whether to change or reuse the IP address of a UE according to the state of the UE, a seamless service can be provided to the UE even when the UE moves to another subnet.

While the invention has been shown and described with reference to certain embodiments thereof, it will be understood by those skilled in the art that various changes in form and details may be made therein without departing from the spirit and scope of the invention as defined by the appended claims.

What is claimed is:

1. A method of communicating using an Internet Protocol (IP) address in a User Equipment (UE) in a mobile communication system, the method comprising:
determining whether radio resources are allocated to a UE, when the UE moves from a first subnet managed by a first gateway to a second subnet managed by a second gateway;
determining whether an IP-based application service is in progress for the UE, in the absence of the allocated radio resources;
determining to reuse a first IP address in the second subnet, the first IP address being an IP address used in the first subnet, if the IP-based application service is in progress;
determining to use a second IP address in the second subnet, if the IP-based application service is not in progress; and
sending to the second gateway a Routing Area Update (RAU) request message including an indication of whether the second IP address or the first IP address will be used in the second subnet.

2. The method of claim 1, wherein the indication includes at least one of the first IP address and a con-indicator indicating whether the first IP address will be reused.

3. The method of claim 1, wherein the sending of the RAU request message comprises:
sending an RAU request message including the first IP address, if the IP-based application service is in progress; and
sending an RAU request message without the first IP address, if the IP-based application service is not in progress.

4. The method of claim 1, wherein the RAU request message comprises at least one of a first RA Identifier (RAI) being an ID of a first RA from which the UE moves, a first Primary Temporary Mobile Station/Subscriber Identity (P-TMSI) of the UE used in the first RA, and the indication.

5. The method of claim 1, further comprising:
receiving from the second gateway an RAU accept message including a second P-TMSI allocated by the second gateway, if the UE determines to reuse the first IP address in the second subnet; and
sending an RAU complete message to the second gateway.

6. The method of claim 5, wherein the RAU accept message is received after the sending of the RAU request message and the RAU complete message is sent in response to the RAU accept message.

7. The method of claim 1, further comprising:
receiving from the second gateway an RAU accept message including a second P-TMSI allocated by the second gateway and an address prefix of the second gateway, if the UE determines to use the second IP address in the second subnet;
generating the second IP address referring to the address prefix; and
sending an RAU complete message including the second IP address to the second gateway.

8. The method of claim 7, wherein the RAU accept message is received after sending the RAU request message.

9. The method of claim 1, further comprising:
receiving from the second gateway an RAU accept message including the second P-TMSI allocated by the second gateway and the second IP address to be used in the second subnet, if the UE determines to use the second IP address in the second subnet; and
sending an RAU complete message to the second gateway.

10. The method of claim 9, wherein the RAU complete message is sent in response to the RAU accept message.

11. A method of supporting communications of a User Equipment (UE) using an Internet Protocol (IP) address in a second gateway in a mobile communication system, the method comprising:
receiving a Routing Area Update (RAU) request message from a UE, when the UE in an idle state moves from a first subnet managed by a first gateway to a second subnet managed by a second gateway;
determining whether the UE will reuse a first IP address in the second subnet, the first IP address being an IP address used in the first subnet, by referring to an indication included in the RAU request message;
registering the first IP address in a routing table for the UE so that the first IP address can be used in the second subnet, if the indication indicates that the first IP address will be reused; and
acquiring a second IP address and storing the second IP address for the UE, if the indication indicates that the first IP address will not be reused.

12. The method of claim 11, further comprising determining the indication according to whether the UE has allocated radio resources and an IP-based application service is in progress for the UE, when the UE moves to the second subnet.

13. The method of claim 12, wherein the indication is set to indicate the reuse of the first IP address, if the UE does not have the allocated radio resources and the IP-based application service is in progress for the UE, and the indication is set to indicate the use of a second IP address, if the UE does not have the allocated radio resources and the IP-based application service is not in progress for the UE.

14. The method of claim 12, wherein the indication includes at least one of the first IP address and a con-indicator indicating whether the first IP address will be reused.

15. The method of claim 11, wherein the determining of whether the UE will reuse a first IP address comprises:
determining that the first IP address will be reused in the second subnet, if the RAU request message includes the first IP address; and
determining that the second IP address will be used in the second subnet, if the RAU request message does not include the first IP address.

16. The method of claim 11, wherein the RAU request message comprises at least one of a first RA Identifier (RAI) being an ID of a first RA from which the UE moves, a first Primary Temporary Mobile Station/Subscriber Identity (P-TMSI) of the UE used in the first RA, and the indication.

17. The method of claim 16, further comprising:
storing the first RAI, the first P-TMSI, and the first IP address in the routing table for the UE, if the second gateway determines that the first IP address will be reused in the second subnet;
sending to the first gateway a gateway context request message including a second RAI being an ID of a second RA to which the UE moves, the first P-TMSI, a second P-TMSI for use in the second subnet, and the indication;
receiving from the first gateway a gateway context response message including a UE context for the UE; and
updating location information of the UE and storing subscriber data of the UE.

18. The method of claim 17, further comprising:
sending an RAU accept message including the second P-TMSI to the UE, after the storing of the location information and the subscriber data; and
receiving an RAU complete message from the UE.

19. The method of claim 17, further comprising:
sending to the first gateway a gateway context request message including the first RAI, the first P-TMSI, and the indication, if the second gateway determines that the first IP address will not be reused in the second subnet
receiving from the first gateway a gateway context response message including the UE context for the UE;
updating the location information of the UE; and
storing the subscriber data of the UE.

20. The method of claim 19, further comprising:
sending an RAU accept message including the second P-TMSI and an address prefix of the second gateway to the UE, after the storing of the location information and the subscriber data; and
receiving an RAU complete message including the second IP address from the UE.

21. The method of claim 20, further comprising:
allocating the second IP address to the UE, after the storing of the location information and the subscriber data;
sending an RAU accept message including the second P-TMSI and the second IP address to the UE; and
receiving an RAU complete message from the UE.

22. The method of claim 11, further comprising:
receiving a paging request message for the UE from the first gateway;
paging the UE;
receiving a paging response message from the UE; and
ending the paging response message to the first gateway so that packets for the UE can be sent from the first gateway to the UE through a second Node B connected to the UE in the second subnet.

23. The method of claim 22 wherein the paging request message is received after a routing area update requested by the RAU request message is completed.

24. The method of claim 23, further comprising:
establishing a first data tunnel with the first gateway after the routing area update requested by the RAU request message is completed;
receiving packets for the UE from the first gateway via the first data tunnel;
paging the UE and receiving a paging response message from the UE;
establishing a second data tunnel with the second Node B; and
sending the packets to the second Node B via the second data tunnel.

25. A method of supporting communications of a User Equipment (UE) using an Internet Protocol (IP) address in a first gateway in a mobile communication system, the method comprising:
receiving a gateway context request message from a second gateway, when the UE in an idle state moves from a first subnet managed by a first gateway to a second subnet managed by the second gateway;
determining whether the UE will reuse a first IP address in the second subnet, the first IP address being an IP address used in the first subnet, by referring to an indication included in the gateway context request message; and
registering a second Routing Area Identifier (RAI) being an ID of a second RA to which the UE moves, and a second Primary Temporary Mobile Station/Subscriber Identity (P-TMSI) allocated to the UE by the second gateway in a routing table for the UE.

26. The method of claim 25, further comprising determining the indication according to whether the UE has allocated radio resources and an IP-based application service is in progress for the UE, when the UE moves to the second subnet.

27. The method of claim 26, wherein the indication is set to indicate the reuse of the first IP address, if the UE does not have the allocated radio resources and the IP-based application service is in progress for the UE, and the indication is set to indicate the use of a second IP address, if the UE does not have the allocated radio resources and the IP-based application service is not in progress for the UE.

28. The method of claim 25, wherein if the indication indicates that the first IP address will be reused, the gateway context request message includes at least one of a first RAI being the ID of a first RA in which the UE is located before the movement, the second RAI, a first P-TMSI used in the first subnet, the second P-TMSI, and the indication.

29. The method of claim 25, further comprising sending to the second gateway a gateway context response message including a UE context for the UE in response to the gateway context request message.

30. An apparatus for communicating using an Internet Protocol (IP) address in a User Equipment (UE) in a mobile communication system, comprising:
a controller for determining whether an IP-based application service is in progress for a UE, when the UE in an idle state moves from a first subnet managed by a first gateway to a second subnet managed by a second gateway, determining to reuse a first IP address in the second subnet, the first IP address being an IP address used in the first subnet, if the IP-based application service is in progress, determining to use a second IP address in the second subnet, if the IP-based application service is not in progress, and generating an indication indicating whether the first IP address or the second IP address will be used in the second subnet; and
a transmitter for sending a Routing Area Update (RAU) request message including the indication to the second gateway.

31. The apparatus of claim 30, wherein the indication includes at least one of the first IP address and a con-indicator indicating whether the first IP address will be reused.

32. The apparatus of claim 30, wherein the transmitter sends an RAU request message including the first IP address, if the IP-based application service is in progress, and sends an RAU request message without the first IP address, if the IP-based application service is not in progress.

33. A mobile communication system comprising:
a plurality of gateways connected to an Internet Protocol (IP) network; and
a User Equipment (UE) capable of communicating using radio resources and supporting an IP-based application service, for determining whether an IP-based application service is in progress for the UE, when the UE in an idle state moves from a first subnet managed by a first gateway to a second subnet managed by a second gateway, determining to reuse a first IP address in the second subnet, the first IP address being an IP address used in the first subnet, if the IP-based application service is in progress, determining to use a second IP address in the second subnet, if the IP-based application service is not in progress, and sending to the second gateway a Routing Area Update (RAU) request message including an indication indicating whether the first IP address or the second IP address will be used in the second subnet.

34. The mobile communication system of claim 33, wherein the indication includes at least one of the first IP address and a con-indicator indicating whether the first IP address will be reused.

35. The mobile communication system of claim 33, wherein the UE sends an RAU request message including the first IP address, if the IP-based application service is in progress, and sends an RAU request message without the first IP address, if the IP-based application service is not in progress.

36. The mobile communication system of claim 33, wherein the second gateway determines that the first IP address will be reused in the second subnet, if the RAU request message includes the first IP address, and determines that the second IP address will be used in the second subnet, if the RAU request message does not include the first IP address.

37. The mobile communication system of claim 33, wherein the second gateway stores the first IP address in a routing table for the UE so that the first IP address can be used in the second subnet, if the second gateway determines that the first IP address will be reused in the second subnet, and acquires the second IP address and stores the second IP address for the UE, if the second gateway determines that the first IP address will not be reused in the second subnet.

38. The mobile communication system of claim 33, wherein if the first gateway determines that the UE will reuse the first IP address in the second subnet, the first gateway registers a second Routing Area Identifier (RAI) being an ID of a second RA to which the UE moves, and a second Primary Temporary Mobile Station/Subscriber Identity (P-TMSI) allocated to the UE by the second gateway in a routing table for the UE.

39. A method of communicating using an Internet Protocol (IP) address in a User Equipment (UE) in a mobile communication system, the method comprising:
moving from a first subnet managed by a first gateway to a second subnet managed by a second gateway;
sending a request message including a first IP address used in the first subnet to the second gateway in order to request reuse of the first IP address in the second subnet; and
receiving from the second gateway a response message indicating the first IP address can be used in the second subnet.

40. The method of claim 39, wherein the UE is in an idle state.

41. The method of claim 39, wherein the request message is a Routing Area Update (RAU) request message.

42. A method of supporting communications of a User Equipment (UE) using an Internet Protocol (IP) address in a second gateway in a mobile communication system, the method comprising:
receiving from a UE a request message with a first IP address used in a first subnet, requesting reuse of the first IP address in a second subnet, when the UE moves from the first subnet managed by a first gateway to the second subnet managed by the second gateway;
registering the first IP address in a routing table for the UE so that the first IP address can be used in the second subnet; and
sending to the UE a response message indicating that the first IP address can be used in the second subnet.

43. The method of claim 42, wherein the UE is in an idle state.

44. The method of claim 42, wherein the request message is a Routing Area Update (RAU) request message.

45. The method of claim 42, further comprising sending to the first gateway a message indicating that the UE will reuse the first IP address in the second subnet, after registering the first IP address.

46. A mobile communication system comprising:
a plurality of gateways connected to an Internet Protocol (IP) network; and
a User Equipment (UE) capable of communicating using radio resources and supporting an IP-based application service for, when the UE moves from a first subnet managed by a first gateway to a second subnet managed by a second gateway, sending a request message including a first IP address used in the first subnet to the second gateway in order to request reuse of the first IP address in the second subnet, and receiving from the second gateway a response message indicating the first IP address can be used in the second subnet.

47. The mobile communication system of claim 46, wherein the UE is in an idle state.

48. The mobile communication system of claim 46, wherein the request message is a Routing Area Update (RAU) request message.

49. The mobile communication system of claim 46, wherein the second gateway receives the request message with the first IP address from the UE and registers the first IP address in a routing table for the UE so that the first IP address can be used in the second subnet.

50. The mobile communication system of claim 49, wherein the second gateway sends to the first gateway a message indicating that the UE will reuse the first IP address in the second subnet, after registering the first IP address.
